(19) United States
(12) Patent Application Publication
(10) Pub. No.: US 2008/0184952 A1
(43) Pub. Date: Aug. 7, 2008

(54) COMPOSITION FOR POWERING ENGINE

(75) Inventor: Dean J. Athans, Crystal Lake, IL (US)

Correspondence Address: BELL, BOYD & LLOYD, LLP, P.O. Box 1135, CHICAGO, IL, 60690, US

(73) Assignee: CONSUMER READY PRODUCTS, LLC, Wilmington, DE (US)

(21) Appl. No.: 11/423,078

(22) Filed: Jun. 8, 2006

Related U.S. Application Data
(60) Provisional application No. 60/688,499, filed on Jun. 8, 2005.

(51) Int. Cl. F02B 47/00; C10L 1/10

(52) U.S. Cl. 123/1 A; 44/300

(57) ABSTRACT

An improved fuel composition for fueling two cycle engines is provided. The fuel composition includes a fuel mixture contained in a container. The fuel mixture includes gasoline and one or more fuel additives which are premixed in a predetermined proportion prior to purchase by a user. The fuel mixture is ready to be supplied to the fuel tank of the engine without any further mixing of the fuel mixture by the user, or optionally, the containerized fuel mixture can be stored prior to supply to the fuel tank.

### PRIORITY CLAIM

This application claims the benefit of U.S. Provisional Patent Application Ser. No. 60/688,499 filed Jun. 8, 2005, which is incorporated herein in its entirety.

### BACKGROUND

The advantages of two cycle engines are well known. They are simple, have a high power/weight ratio, can be manufactured at a low cost, and are reliable. For these reasons, two cycle engines are ideal for sport vehicles, marine engines, and portable power appliances where the engine must be lifted, held, or carried by hand, such as equipment used in forestry, lawn, garden, construction, and fire suppression. Common applications include chain saws, weed cutters, snow blowers, lawnmowers, jet skis, mopeds, outboard motors, some motorcycles, and the like.

Two cycle engines are fueled by using a fuel mixture which includes gasoline and an additive, such as a lubricating oil, at prescribed proportions. The two cycle engine system introduces a fuel mixture of gasoline and lubricating oil into the combustion chamber, compresses it, and then ignites the mixture with a spark plug. Running a two cycle engine on gasoline alone causes damage to the engine and reduce the life of the engine significantly. Lubricating two cycle engines is achieved by mixing oil with gasoline and then transferring this fuel mixture to the engine. The oil is burned upon combustion of the fuel mixture.

In general, most two cycle engines require the gasoline and oil to be mixed at certain ratios, such as a 25:1, 32:1, 40:1, and 50:1. For example, the 50:1 ratio calls for 50 parts of gasoline to 1 part of oil. Since one gallon of fuel is 128 fluid ounces, 2.56 fluid ounces of oil must be combined with 1 gallon of gasoline to achieve the recommended 50:1 mix ratio. Different mixing ratios are used to accommodate the various requirements of the equipment manufacturers.

The following tables summarize the amounts of each component required to mix fuels with 50:1 and 40:1 gasoline to oil ratios, respectively.

TABLE 1
Fuel With Gasoline to Oil Ratio of 50:1

| Gasoline, gal. | Oil (Additive), oz. |
|---|---|
| 1 | 2.56 |
| 2 | 5.12 |
| 3 | 7.68 |
| 4 | 10.24 |
| 5 | 12.80 |

TABLE 2
Fuel With Gasoline to Oil Ratio of 40:1

| Gasoline, gal. | Oil (Additive), oz. |
|---|---|
| 1 | 3.20 |
| 2 | 6.40 |
| 3 | 9.60 |
| 4 | 12.80 |
| 5 | 16.00 |

Known containers for containing fuel typically hold slightly more than 1 gallon. This characteristic of fuel containers can cause a user to unknowingly add an excessive amount of gasoline to the fuel tank, thereby diluting the oil in the mixture. As a result, the mixing ratio of gasoline to oil in the fuel is improper.

Incorrect gasoline to oil ratios can have a detrimental effect on the lubrication function and the combustion performance of the two cycle engine. Two cycle engines have little, if any, adjustability to compensate for fuel variables. Serious engine damage can and will occur if the fuel mixture deviates from the recommended gasoline to oil ratio. Moreover, incorrect proportions of gasoline to oil in the fuel alter the emission outputs, causing excessive smoke.

When adding fuel to a two cycle engine, special precautions should be taken to maintain the proper mix ratio needed for engine fuel. It is also recommended that a fuel tank of a two cycle engine be drained after each use. Failure to drain a fuel tank completely before adding fresh fuel components increases the risk of mixing fuel which contains improper proportions of gasoline and oil, or fuel containing amounts of old fuel which was not completely discarded. The presence of old fuel contributes to poor engine performance.

One major disadvantage involved with use of a two cycle engine is that, before operating the tool or appliance, a user must mix the fuel for the two cycle engine. The mixing step is inconvenient and can create unsafe conditions for the user. Additionally, it is difficult to achieve the proper mix ratios of gasoline to oil for various fuel tank sizes. Improper mix ratios cause unreliable starting, poor performance, and shortened engine life.

Another disadvantage involved with two cycle engines is that users incur extra costs associated with having to mix the gasoline and oil to fuel the two cycle engine. For example, the user must purchase a container to hold the gasoline and oil during mixing, and in addition, the user must purchase the oil and the gasoline separately.

One known system for fueling a two cycle engine provides a disposable fuel tank which is prefilled with fuel. In this system, the disposable fuel tank is supplied to a user ready for use, and the fuel contained in the disposable fuel tank has premixed additives to improve engine performance. However, in this system, the disposable fuel tank is designed to accommodate only a particular type of engine which includes brackets for securing the fuel tank within the engine. Thus, providing such disposable fuel tanks prefilled with fuel does not give users the flexibility to use the fuel for any two cycle engine other than the particular type specific to the disposable fuel tank. Further, the disposable fuel tank may not be convenient in size and structure for the user to store prior to use, thus impeding its use of same.

It would be advantageous to provide a premixed fuel composition which is ready for use upon purchase for supplying fuel to a two cycle engine.

### SUMMARY

The present disclosure relates to an improved fuel composition for use in two-cycle engines. The present disclosure also relates to a method of producing and a method for providing an improved fuel composition for use in a two cycle engine.

In one embodiment, the present disclosure provides a fuel composition for use in a two cycle engine which is available for purchase. The fuel composition includes a fuel mixture. The fuel mixture includes a volume of gasoline and a volume of one or more fuel additives, such as lubricating oil. The gasoline and the oil are mixed according to a predetermined proportion before the point of purchase. The fuel mixture is ready for use in a two cycle engine upon purchase. That is, upon purchase, the fuel mixture is ready to be supplied to the fuel tank of the engine without any further mixing of the fuel mixture.

In one embodiment, the present disclosure provides a containerized fuel composition for use in a two-cycle engine and available for purchase. The containerized fuel composition includes a fuel mixture and a container for containing said fuel mixture.

In one embodiment, the container is a can, bottle, or any other suitable type of container made from any suitable material. In one embodiment, the container includes a means for dispensing the fuel mixture into a fuel tank of an engine. Thus, the fuel mixture is supplied to the two cycle engine by dispensing the premixed fuel mixture from the container into the fuel tank of the engine.

In one embodiment, the container is constructed to contain a volume of the fuel mixture which is capable of filling said fuel tank of said engine to capacity. It should be appreciated that fuel tanks come in various sizes. Thus, the present disclosure contemplates providing in an embodiment containers of varying sizes for containing a number of different volumes of fuel which correspond to the sizes of fuel tanks commonly found in two-cycle engines. This eliminates or reduces the occurrence of unused and wasted fuel.

In one embodiment, the fuel mixture further includes a stabilizer. The stabilizer prevents deterioration, thus allowing the fuel mixture to be stored prior to use. In one embodiment, the fuel mixture further includes a marker. The marker indicates to a user when the proportion of gasoline and oil in the fuel mixture has been distorted, or when other substances or contaminants are present in the fuel mixture.

In one embodiment, the present disclosure provides a method of producing a containerized fuel composition. The method includes preparing a fuel mixture capable for use in a two cycle engine, containing the fuel mixture in a container, and sealing the container, thereby allowing the containerized fuel composition upon purchase to be ready for supply to a fuel tank of the two cycle engine without further mixing of the fuel mixture prior to use.

In another embodiment, the present disclosure provides a method for providing a containerized fuel composition to power a two cycle engine. The method includes providing a container containing a fuel mixture, wherein the fuel mixture is capable for ready use in the two cycle engine without further mixing prior to purchase, and supplying the fuel mixture to a fuel tank of the engine. In yet another embodiment, the method provides filling the fuel tank of the engine to capacity with the fuel mixture such that no fuel mixture remains in the container.

Accordingly, an advantage of the present disclosure is to provide a fuel composition including a composition which is premixed and ready to use at the time of purchase and, optionally, can be stored prior to use.

Another advantage of the present disclosure is to provide a containerized fuel composition premixed to ensure optimal performance and longer life of the engine.

A further advantage of the present disclosure is to provide a fuel composition which eliminates the need to purchase a gas can for mixing the gasoline and oil, or to purchase the gasoline, oil, and other fuel additives separately.

Another advantage of the present disclosure is to provide a fuel composition which eliminates the need for users to handle potentially dangerous materials while mixing gasoline and oil.

Yet another advantage of the present disclosure is to provide a container of a premixed fuel composition with a volume capacity that corresponds to the capacity of the fuel tank of the engine that the user wishes to operate.

Still yet another advantage is to provide a containerized fuel mixture that is designed to alert the user as to whether the fuel mixture is ready for use in a two cycle engine.

Additional features and advantages of the present disclosure are described in and will be apparent from the following Detailed Description and the figures.

### BRIEF DESCRIPTION OF THE FIGURES

FIG. 1 is a perspective view of an embodiment of the containerized fuel composition of the present disclosure.

FIG. 2 is a perspective view of an embodiment of the containerized fuel composition of the present disclosure, wherein the fuel mixture is supplied to a fuel tank of a two cycle engine.

### DETAILED DESCRIPTION

The present disclosure generally relates to fuel compositions for fueling two cycle engines. More specifically, the present disclosure relates to an improved fuel composition, a method of producing, and a method for providing the improved fuel composition. The improved fuel composition and methods for producing and providing the improved fuel composition according to various embodiments of the present disclosure are described in detail below.

As discussed above, a problem associated with two cycle engines is that a user must mix oil and gasoline to make the fuel for use in the two cycle engine. Failure to mix the gasoline and oil in accurate proportions results in serious engine damage and ultimately reduces engine life and performance. It is inconvenient and difficult for users to achieve the appropriate mixing ratio of gasoline to oil.

In one embodiment, the present disclosure provides a fuel composition for use in a two cycle engine which is available for purchase. The fuel composition includes a fuel mixture. The fuel mixture includes a fuel and a fuel additive. In one embodiment, the fuel is gasoline and the fuel additive is a lubricating oil. The gasoline and the oil are mixed in a predetermined proportion prior to the point of purchase. The fuel mixture is ready for use in a two cycle engine upon purchase by a user. That is, at the point of purchase, the fuel mixture is ready to be supplied to a fuel tank of the engine without any further mixing of the fuel mixture. Optionally, the containerized fuel mixture can be readily stored prior to use.

In one embodiment, the predetermined proportion of gasoline mixed with fuel is 25:1, 32:1, 40:1, 50:1, or any other suitable mixing ratio.

In one embodiment, the gasoline is 89 octane or higher. It should be appreciated that 89 octane gasoline is recommended by engine manufacturers. If gasoline octane is too low, the fuel can ignite prematurely and spontaneously thereby causing the fuel charge to explode rather than burn. This results in incomplete combustion, and the overall effect is a loss in power and possible damage to the engine. Higher octane gasoline, such as 89 octane, performs better in the combustion process. Preferably, the gasoline does not contain ethanol or methanol. Ethanol and methanol can cause damage to engine parts because ethanol and methanol have a tendency to absorb moisture from the air into the fuel, causing engine performance problems.

In one embodiment, the lubricating oil is a premium blend oil formulation or any other suitable type of two cycle oil formulation. It should be appreciated that the oil formulations used in marine applications are slightly different from the oil formulations used in other types of two cycle engines.

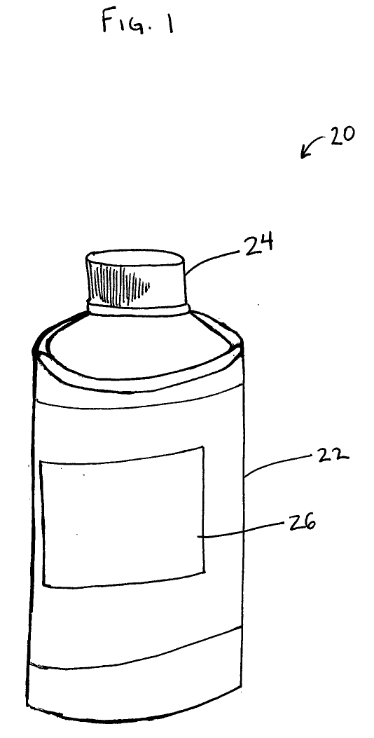

Referring now to FIG. 1, in one embodiment, the present disclosure provides a containerized fuel composition 20 for use in a two cycle engine which is available for purchase. The containerized fuel composition includes a fuel mixture and a container 22 for containing said fuel mixture.

In one embodiment, the container 22 for containing the fuel mixture is a can, bottle, or any other suitable type of container made from any suitable material. In one preferred embodiment, the container 22 holds approximately 14 to 32 fluid ounces. This size is the typical size of a variety of different commonly used fuel tanks in two-cycle engines. In other embodiments, the container 22 is any container of suitable size and shape. In one embodiment, the container 22 is made of steel or any other suitable material. In one embodiment, the container 22 includes a cap 24 or any other type of closure or lid which functions to firmly and securely seal the container 22. In another embodiment, the container 22 includes one or more safety features, such as a child-resistant closure or one or more labels 26.

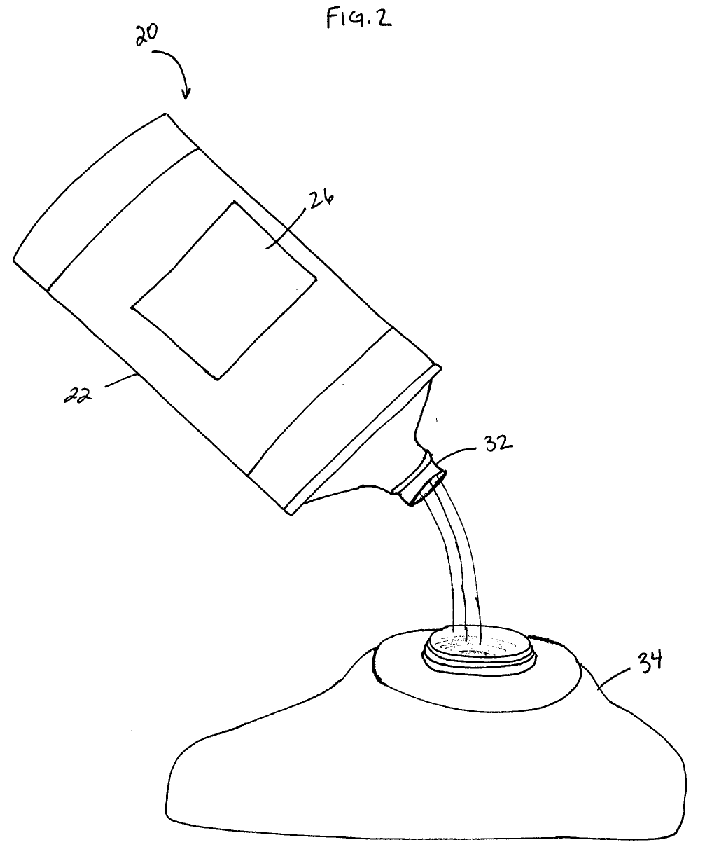

Referring now to FIG. 2, in one embodiment, the container 22 includes a means for dispensing the fuel mixture into a fuel tank 34 of an engine 32, such as a spout or an elongated upper portion of the container 22. The fuel mixture is supplied to the two cycle engine by dispensing or pouring the premixed fuel mixture from the container 22 into the fuel tank 34 of the engine. It should be appreciated that the premixed fuel mixture contained in the container 22 can be dispensed into and used for the fuel tank of any application employing a two cycle engine.

In one embodiment, the container 22 is constructed to hold a volume of the fuel mixture which is capable of filling the fuel tank 34 of the engine to capacity. Since fuel tanks come in a variety of sizes, the present disclosure contemplates providing in an embodiment containers of varying sizes for containing a number of different volumes of fuel which correspond to the sizes of fuel tanks commonly found in two-cycle engines. This eliminates or reduces the occurrence of unused and wasted fuel. In one embodiment, the container 22 is disposable, and can thus be thrown away after its contents are emptied into the fuel tank of the engine.

In one embodiment, the fuel mixture further includes a stabilizer. The stabilizer prevents deterioration during storage. Fuel that is left sitting in power tools, sport vehicles, or other equipment will often deteriorate after a short period of time. Over time, this causes the engine to not start. A stabilizer reduces the oxidation process of the fuel and thereby prevents the fuel from deteriorating when it is stored or kept for later use. Further, this allows the containerized fuel mixture to be stored prior to use.

In another embodiment, the fuel mixture includes a marker. The marker provides an indication to the user if the proportions of gasoline and oil in the fuel mixture have been distorted, or if other substances have been added to or have contaminated the fuel mixture. The marker may include the appearance of a color, a change in color, a smell, or any other suitable indicator to alert a user that the fuel mixture is contaminated or otherwise undesirable for use.

In one embodiment, the present disclosure provides a method of producing a containerized fuel composition. The method includes preparing a fuel mixture capable for use in a two cycle engine, containing the fuel mixture in a container, and sealing the container, thereby allowing the containerized fuel composition upon purchase to be ready for supply to a fuel tank of the two cycle engine without further mixing of the fuel mixture prior to use.

In one embodiment, the method further includes filling the fuel tank of the engine to capacity with the fuel mixture such that no fuel mixture remains in the container. As noted above, in some embodiments, a container holds a volume of fuel that corresponds to the capacity of the fuel tank in the engine. Thus, when the fuel tank is filled to capacity, there is no fuel mixture remaining in the container. In one embodiment, the method further includes disposing of the container after filling the fuel tank of the engine.

In another embodiment, the present disclosure provides a method for providing a containerized fuel composition to power a two cycle engine. The method includes providing a container containing a fuel mixture, wherein the fuel mixture is capable for ready use in the two cycle engine without further mixing prior to purchase, supplying the fuel mixture to a fuel tank of the engine, and filling said fuel tank of the engine to capacity with the fuel mixture such that no fuel mixture remains in the container.

Whereas many alterations and modifications of the present invention will no doubt become apparent to a person of ordinary skill in the art after having read the foregoing description, it is to be understood that any particular embodiment shown and described is in no way intended to be considered limiting. Therefore, references to details of various embodiments are not intended to limit the scope of the claims, which in themselves recite only those elements regarded as essential to the invention.

The invention is claimed as follows:

1. A fuel composition for use in a two-cycle engine and available for purchase, said fuel composition comprising:
a fuel mixture including a fuel and fuel additive;
wherein, upon purchase of said fuel composition, said fuel mixture is ready to be supplied to a fuel tank of said engine without further mixing of said fuel mixture.

2. The fuel composition of claim 1, wherein said fuel additive is a lubricating oil, and wherein said fuel is gasoline.

3. The fuel composition of claim 2, wherein said gasoline and said oil are mixed in a predetermined proportion.

4. The fuel composition of claim 3, wherein the predetermined proportion of gasoline to oil is selected from the group consisting of: 25:1, 32:1, 40:1, and 50:1.

5. The fuel composition of claim 1, wherein said mixture further includes a fuel stabilizer.

6. The fuel composition of claim 1, wherein said fuel mixture further includes a marker.

7. A containerized fuel composition for use in a two-cycle engine and available for purchase, said containerized fuel composition comprising:
a fuel mixture; and
a container for containing said fuel mixture;
wherein, upon purchase by a user, said fuel mixture is ready to be supplied to a fuel tank of said engine without further mixing of said fuel mixture by said user.

8. The containerized fuel composition of claim 7, wherein said fuel mixture includes a volume of gasoline and a volume of fuel additive mixed in a predetermined proportion of gasoline to oil.

9. The containerized fuel composition of claim 8, wherein said fuel additive is a lubricating oil.

10. The containerized fuel composition of claim 9, wherein the predetermined proportion of gasoline to oil is selected from the group consisting of: 25:1, 32:1, 40:1, and 50:1.

11. The containerized fuel composition of claim 8, wherein said fuel mixture further includes a stabilizer.

12. The containerized fuel composition of claim 8, wherein said fuel mixture further includes a marker.

13. The containerized fuel composition of claim 7, wherein said container is a can or a bottle.

14. The containerized fuel composition of claim 7, wherein said container is made of steel.

15. The containerized fuel composition of claim 7, wherein said container includes a means for dispensing said fuel mixture into said fuel tank.

16. The containerized fuel composition of claim 7, wherein said container contains a volume of said fuel mixture which is capable of filling said fuel tank of said engine to capacity.

17. The containerized fuel composition of claim 7, wherein said container is disposable.

18. A method of producing a containerized fuel composition, said method comprising:
preparing a fuel mixture capable for use in a two cycle engine;
containing said fuel mixture in a container; and
sealing said container, thereby allowing the containerized fuel composition upon purchase to be ready to supply to a fuel tank of said two cycle engine without further mixing of the fuel mixture.

19. The method of claim 18, wherein said fuel mixture includes a volume of gasoline and a volume of lubricating oil.

20. The method of claim 19 wherein the said volume of gasoline and said volume of lubricating oil are combined in a predetermined proportion.

21. The method of claim 20, wherein said predetermined proportion of gasoline to oil is selected from the group consisting of: 25:1, 32:1, 40:1, and 50:1.

22. The method of claim 18 which includes adding a stabilizer to said fuel mixture.

23. The method of claim 18 which includes adding a marker to said fuel mixture.

24. The method of claim 18, wherein said container includes a means for dispensing said fuel mixture into said fuel tank.

25. The method of claim 18, which includes filling the fuel tank of the engine to capacity with said fuel mixture such that no fuel mixture remains in said container.

26. A method of providing a containerized fuel composition to power a two cycle engine, said method comprising:
providing a container containing a fuel mixture, said fuel mixture capable for ready use in the two cycle engine prior to purchase without further mixing;
supplying the fuel mixture to a fuel tank of the engine; and
filling said fuel tank of the engine to capacity with the fuel mixture such that no fuel mixture remains in the container.

27. The method of claim 26 wherein the fuel mixture includes a volume of gasoline and a volume of lubricating oil that are combined in a predetermined proportion of gasoline to oil.

28. The method of claim 27, wherein said predetermined proportion is selected from the group consisting of: 25:1, 32:1, 40:1, and 50:1.

29. The method of claim 26 which includes adding a stabilizer to said fuel mixture.

30. The method of claim 26 which includes adding a marker to said fuel mixture.

31. The method of claim 26, wherein said container includes a means for dispensing said fuel mixture into said fuel tank.

32. The method of claim 26, which includes disposing of said container after filling said fuel tank of said engine.
